(19) United States
(12) Patent Application Publication
(10) Pub. No.: US 2024/0060844 A1
(43) Pub. Date: Feb. 22, 2024

(54) OBSERVATION DEVICE AND OBSERVATION METHOD

(71) Applicant: FANUC CORPORATION, Yamanashi (JP)

(72) Inventors: Koki KAMETA, Yamanashi-ken (JP); Sichen LIU, Yamanashi-ken (JP)

(21) Appl. No.: 18/260,108

(22) PCT Filed: Jan. 5, 2022
(86) PCT No.: PCT/JP2022/000060

§ 371 Date: Jun. 30, 2023

(30) Foreign Application Priority Data
Jan. 7, 2021 (JP) 2021-001367

(51) Int. Cl. G01M 1/16; G01B 21/22; B23Q 17/22

(52) U.S. Cl. CPC G01M 1/16; G01B 21/22; B23Q 17/22

(57) ABSTRACT

An observation device observes a balance state of a main spindle of a machine tool including the main spindle and a moving body to which the main spindle is rotatably fixed and which moves in a direction orthogonal to the axial direction of the main spindle. The observation device includes a first acquisition unit for acquiring rotation angles of the main spindle during rotation; a second acquisition unit for acquiring movement information indicating a movement state of the moving body when the main spindle is rotating; and an output generation unit for displaying, on a display unit, each of the rotation angles of the main spindle and the movement information in association with each other.

### TECHNICAL FIELD

The present invention relates to an observation device and an observation method configured to observe a state of a spindle of a machine tool.

### BACKGROUND ART

In JP H03-251066 A, a field balancer is disclosed. The field balancer is a device for measuring a balance state of a rotationally driven measurement target. The measurement target, for example, is a motor (a motor shaft).

### SUMMARY OF THE INVENTION

An operator of a machine tool (for example, a lathing machine) uses the field balancer, for example, in order to measure a balance state of a main shaft (spindle) of the machine tool. In this instance, the operator mounts the field balancer (an acceleration pickup sensor) on the machine tool. However, the operation of mounting the field balancer on the machine tool requires time and effort. Further, the accuracy in observing the balance state of the main shaft by the field balancer depends on the manner in which the field balancer is attached to the machine tool, and the position where the field balancer is installed. Accordingly, it is difficult for anyone to investigate the balance state of the main shaft with stable and consistent observation accuracy.

The present invention has the object of solving the aforementioned problems.

A first aspect of the present invention is characterized by an observation device configured to observe a balance state of a main shaft of a machine tool, wherein the machine tool is equipped with the main shaft, and a moving body to which the main shaft is fixed so as to be rotatable and that is configured to move in a direction perpendicular to an axial direction of the main shaft, and the observation device includes a first acquisition unit configured to acquire angles of rotation of the main shaft that is rotating, a second acquisition unit configured to acquire movement information indicating a state of movement of the moving body at a time when the main shaft is rotating, and an output generation unit configured to cause a display unit to display each of the angles of rotation of the main shaft, and the movement information in association with each other.

A second aspect of the present invention is characterized by an observation method of observing a balance state of a main shaft of a machine tool, wherein the machine tool is equipped with the main shaft, and a moving body to which the main shaft is fixed so as to be rotatable and that is configured to move in a direction perpendicular to an axial direction of the main shaft, the observation method including a first acquisition step of acquiring angles of rotation of the main shaft that is rotating, a second acquisition step of acquiring movement information indicating a state of movement of the moving body at a time when the main shaft is rotating, and an output generation step of causing a display unit to display each of the angles of rotation of the main shaft, and the movement information in association with each other.

According to the aspects of the present invention, the balance state of the main shaft of the machine tool can be observed without needing to use a field balancer.

### BRIEF DESCRIPTION OF DRAWINGS

FIG. 1 is a configuration diagram of an observation system according to an embodiment;

FIG. 2 is a configuration diagram of an observation device according to the embodiment;

FIG. 3 is a graph illustrating on a time axis an angle of rotation of a main shaft that is acquired by a first acquisition unit;

FIG. 4 is a graph illustrating a phase of a positional deviation of a moving body that is acquired by a second acquisition unit;

FIG. 5 is a diagram illustrating an observation result of a balance state of the main shaft as observed by the observation device according to the embodiment;

FIG. 6 is a flowchart illustrating a process flow of an observation method according to the embodiment;

FIG. 7 is a configuration diagram of the observation system according to an Exemplary Modification 4;

FIG. 8 is a configuration diagram of the observation device according to an Exemplary Modification 5;

FIG. 9 is a graph illustrating the transitioning over time of the positional deviation of the moving body;

FIG. 10 is a configuration diagram of the observation device according to an Exemplary Modification 6;

FIG. 11 is a graph illustrating phases, on a time axis, of the angle of rotation of the main shaft and the positional deviation before and after being compensated by a compensation unit;

FIG. 12 is a graph for the purpose of describing a compensation amount that is stored in a storage unit;

FIG. 13 is a configuration diagram of the observation device according to an Exemplary Modification 7; and

FIG. 14 is a diagram illustrating an observation result of a balance state of the main shaft as observed by the observation device according to the Exemplary Modification 7.

### DETAILED DESCRIPTION OF THE INVENTION

### Embodiments

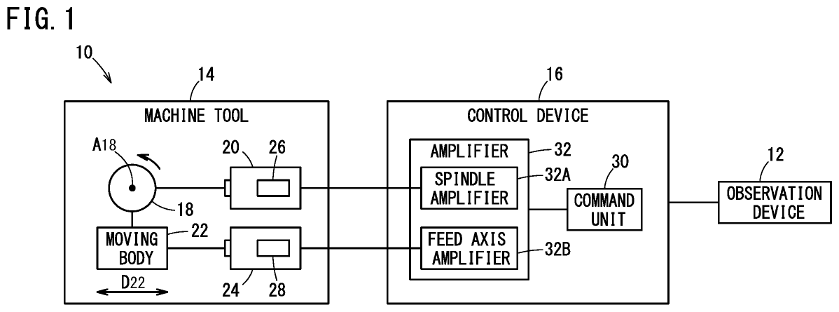

FIG. 1 is a configuration diagram of an observation system 10 according to an embodiment.

The observation system 10 includes a machine tool 14, a control device 16, and an observation device 12. The control device 16 is connected to the machine tool 14 so as to be capable of controlling the machine tool 14. The control device 16 and the observation device 12 are connected in a manner so as to be capable of communicating with each other.

The machine tool 14, for example, is a lathing machine. The machine tool 14 is equipped with a main shaft (spindle) 18, a main shaft motor 20, a moving body 22, and a feed axis motor 24. The main shaft 18 rotates centrally about an axis A₁₈ (refer to FIG. 1). The main shaft motor 20 is a spindle motor. The main shaft motor 20 causes the main shaft 18 to rotate. A drive current is supplied to the main shaft motor 20. Consequently, the main shaft motor 20 is driven. The main shaft 18 undergoes rotation in accordance with the main shaft motor 20 being driven.

A first detector 26 is provided in the main shaft motor 20. The first detector 26, for example, is a rotary encoder. The first detector 26 outputs a signal corresponding to the angle of rotation of the shaft of the main shaft motor 20. The first detector 26 feeds back such a signal to a main shaft amplifier 32A. The main shaft amplifier 32A will be described later.

The moving body 22 causes the main shaft 18 to move along a movement direction D₂₂. The movement direction D₂₂ is a direction perpendicular to the direction in which the axis A₁₈ extends (refer to FIG. 1). The moving body 22 is connected to a feed axis motor 24 via a non-illustrated conversion mechanism. The non-illustrated conversion mechanism, for example, is a ball screw mechanism. The non-illustrated conversion mechanism converts a rotational force generated by the feed axis motor 24 into a linear force in the movement direction D₂₂, and transmits the linear force to the moving body 22. The moving body 22 moves along the movement direction D₂₂ in accordance with the linear force transmitted from the non-illustrated conversion mechanism. The main shaft 18 is fixed to (supported by) the moving body 22 so as to be capable of rotating. Accordingly, when the moving body 22 moves in the movement direction D₂₂, the main shaft 18 moves together therewith in the movement direction D₂₂.

The feed axis motor 24 is a servomotor for the purpose of controlling the movement of the moving body 22. A drive current is supplied to the feed axis motor 24. Consequently, the shaft of the feed axis motor 24 is rotationally driven. As a result, the feed axis motor 24 produces the aforementioned rotational force. Moreover, also in the case that the position of the moving body 22 is maintained, the feed axis motor 24 receives a supply of the drive current.

A second detector 28 is provided in the feed axis motor 24. The second detector 28, for example, is a rotary encoder. The second detector 28 outputs a signal corresponding to the angle of rotation of the shaft of the feed axis motor 24. The second detector 28 feeds back such a signal to a feed axis amplifier 32B. The feed axis amplifier 32B will be described later.

The machine tool 14 may be equipped with a plurality of the feed axis motors 24. In that case, the plurality of the feed axis motors 24 may move the moving body 22 along mutually different directions. The feed axis motor 24 may be a linear motor. In that case, the feed axis motor 24 includes a linear moving axis. Further, the second detector 28 detects the position of the linear moving axis of the feed axis motor 24. The second detector 28, which detects the position of the linear moving axis of the feed axis motor 24, for example, is a linear encoder. In the case that the feed axis motor 24 is a linear motor, the feed axis motor 24 produces a linear force. In that case, the aforementioned conversion mechanism is unnecessary.

The control device 16 is a numerical control device that feedback-controls the machine tool 14. The control device 16 includes a command unit (a processor) 30 and an amplifier 32. The command unit 30 generates a control command in order to numerically control the main shaft motor 20 and the feed axis motor 24. Further, the command unit 30 outputs the generated control command to the amplifier 32. Moreover, it should be noted that the command unit 30 may receive a command from the observation device 12 based on an observation control command 41 (details of this feature will be described later). In this case, based on the observation control command 41, the command unit 30 outputs the control command to the amplifier 32.

The amplifier 32 includes the main shaft amplifier 32A, and the feed axis amplifier 32B. The main shaft amplifier 32A is a drive device that is connected to the command unit 30 and the main shaft motor 20. The main shaft amplifier 32A supplies a drive current to the main shaft motor 20, based on the control command from the command unit 30, and the angle of rotation of the shaft of the main shaft motor 20. Moreover, the angle of rotation of the shaft of the main shaft motor 20 is calculated based on the output signal of the first detector 26. The feed axis amplifier 32B is a drive device that is connected to the command unit 30 and the feed axis motor 24. The feed axis amplifier 32B supplies a drive current to the feed axis motor 24, based on the control command from the command unit 30, and the angle of rotation of the feed axis motor 24. Moreover, the angle of rotation of the feed axis motor 24 is calculated based on the output signal of the second detector 28.

The machine tool 14 and the control device 16 have been described above. Subsequently, the observation device 12 will be described below.

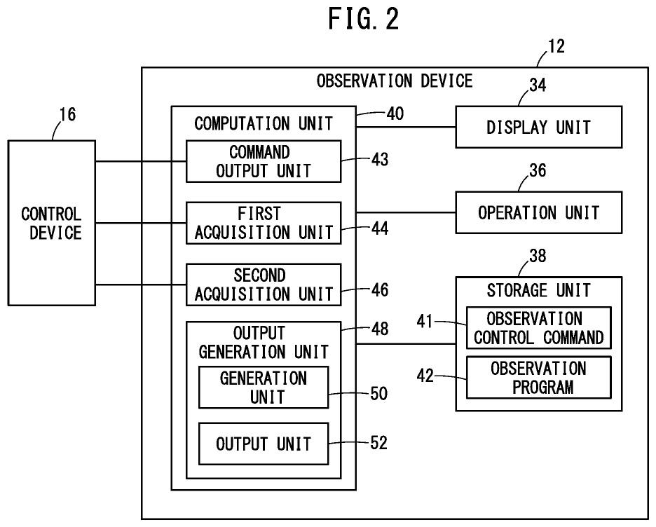

FIG. 2 is a configuration diagram of the observation device 12 according to the embodiment.

The observation device 12 is an electronic device (a computer) for the purpose of observing a balance state of the main shaft 18. As will be described in detail below, the observation device 12 observes the balance state of the main shaft 18 by associating on a time axis an angle of rotation of the main shaft 18, and information (movement information) indicating a state of movement of the moving body 22.

The observation device 12 acquires the movement information. The movement information, for example, is a positional deviation of the moving body 22. Moreover, the control device 16 feedback-controls the feed axis motor 24. The positional deviation of the moving body 22 is generally calculated in a process of the feedback control. Accordingly, the observation device 12 is capable of acquiring the positional deviation of the moving body 22 from the control device 16.

The movement information preferably includes a large number of deviation components that are affected by the influence of vibrations transmitted from the main shaft 18. Accordingly, it is preferable that the observation device 12 acquires the movement information in a state in which the control device 16 is controlling the feed axis motor 24 in order to keep the moving body 22 stationary.

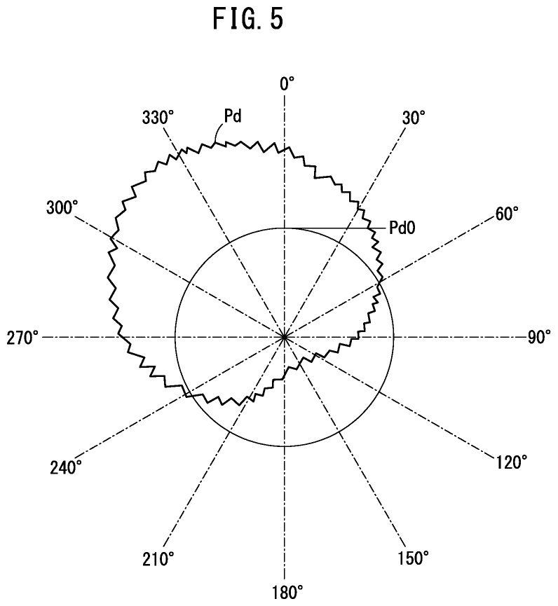

Based on the foregoing preliminary explanation, a configuration example of the observation device 12 which is capable of obtaining the observation results illustrated in FIG. 5 will be explained below. The observation device 12 is equipped with a display unit 34, an operation unit 36, a storage unit 38, and a computation unit 40.

The display unit 34 is a display device having a screen. The screen, for example, is a liquid crystal screen. Information is displayed on the screen as appropriate. For example, the observation result of FIG. 5 is displayed on the screen.

The operation unit 36 is an input device that receives information input thereto. The operation unit 36 includes, for example, a keyboard, a mouse, and a touch panel. However, the operation unit 36 may also include an operation panel. The touch panel is installed, for example, on the screen of the display unit 34. The operator, for example, via the operation unit 36, can issue an instruction to the observation device 12 to initiate observation of the balance state.

The storage unit 38 includes a memory that stores information. The storage unit 38 includes a RAM (Random Access Memory) and a ROM (Read Only Memory). The storage unit 38 stores the observation control command 41, and a predetermined observation program 42.

The observation control command 41 is information including command content in order to issue instructions to the control device 16. The observation control command 41 includes a command for causing the main shaft 18 to rotate. Further, it is preferable that the observation control command 41 further includes a command for the purpose of maintaining the position of the moving body 22 at a predetermined position.

The observation program 42 is a program in order to cause the observation device 12 to execute an observation method according to the present embodiment. The details of such an observation method will be described later.

The computation unit 40 includes a processor that processes information by performing calculations. The computation unit 40 includes a CPU (Central Processing Unit), and a GPU (Graphics Processing Unit).

The computation unit 40 is equipped with a command output unit 43, a first acquisition unit 44, a second acquisition unit 46, and an output generation unit 48. Each of the command output unit 43, the first acquisition unit 44, the second acquisition unit 46, and the output generation unit 48 is realized by the observation program 42 being executed by the computation unit 40.

The command output unit 43 outputs commands including at least the observation control command 41 to the control device 16. Consequently, the control device 16 controls the main shaft motor 20 in order to rotate the main shaft 18. In this instance, the control device 16 may gradually increase the rotational speed of the shaft of the main shaft motor 20 at a constant acceleration. Further, the control device 16 may increase the rotational speed of the shaft of the main shaft motor 20 in a stepwise manner. Further, the control device 16 controls the feed axis motor 24 in order to maintain the position of the moving body 22 at a predetermined position. For example, in the case that the position of the moving body 22 deviates from the predetermined position, the control device 16 causes the moving body 22 to be moved to the predetermined position.

The first acquisition unit 44 acquires the angle of rotation of the main shaft 18. Moreover, it should be noted that the angle of rotation of the main shaft 18 and the angle of rotation of the shaft of the main shaft motor 20 coincide with each other. In this instance, in order to feedback-control the main shaft motor 20, the control device 16 calculates the angle of rotation of the shaft of the main shaft motor 20. Accordingly, the first acquisition unit 44 may acquire the angle of rotation of the shaft of the main shaft motor 20 from the control device 16. Consequently, the first acquisition unit 44 substantially acquires the angle of rotation of the main shaft 18.

The storage unit 38 stores the acquired angle of rotation of the main shaft 18.

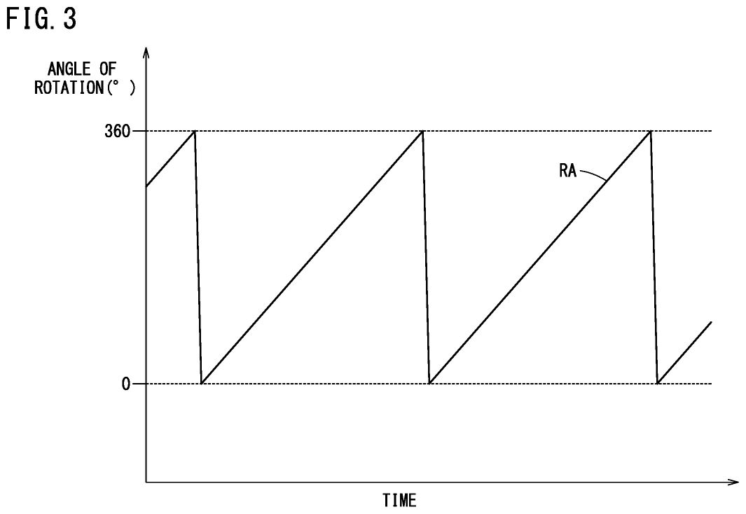

FIG. 3 is a graph illustrating on a time axis the angle of rotation of the main shaft 18 that is acquired by the first acquisition unit 44.

The graph illustrated in FIG. 3 shows a phase (RA) of the angle of rotation of the main shaft 18. The graph of FIG. 3 includes a vertical axis indicating the angle of rotation, and a horizontal axis indicating time. Moreover, in FIG. 3, the range of the angle of rotation is from 0 degrees to 360 degrees (one rotation of the main shaft 18). However, the range of the angle of rotation is not limited to this range.

The second acquisition unit 46 acquires the movement information from the control device 16. In this instance, the control device 16 controls the feed axis motor 24 in order to keep the moving body 22 stationary at the predetermined position. Accordingly, the movement information includes a large number of deviation components that are affected by the influence of vibrations transmitted from the main shaft 18.

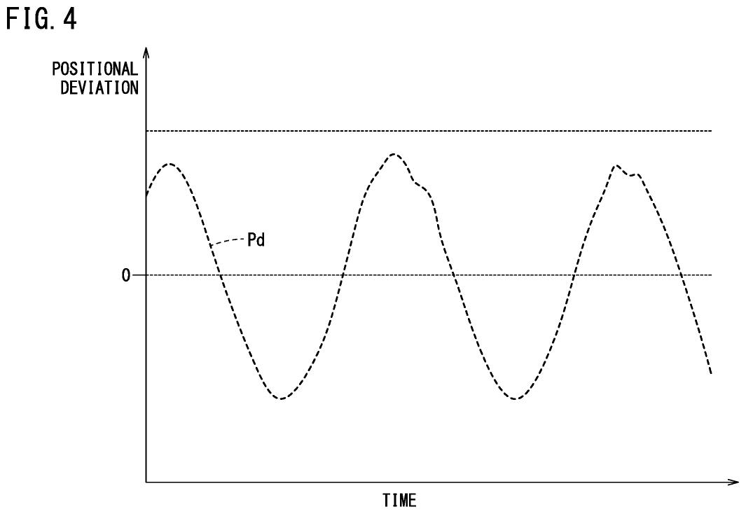

FIG. 4 is a graph illustrating on a time axis the positional deviation of the moving body that is acquired by the second acquisition unit 46.

The graph illustrated in FIG. 4 shows the phase of the positional deviation (Pd) of the moving body 22. The graph of FIG. 4 includes a vertical axis representing the positional deviation, and a horizontal axis representing time. The positional deviation of the moving body 22 fluctuates in accordance with the vibrations of the moving body 22. The vibrations are transmitted to the moving body 22 from the main shaft 18. In other words, due to the main shaft 18 undergoing rotation, vibrations are generated. In this instance, the amount of vibration of the main shaft 18 changes in accordance with the balance state of the main shaft 18. Accordingly, a transition in the positional deviation indirectly indicates a change in the balance state of the main shaft 18.

The output generation unit 48 generates an observation result (see FIG. 5) based on the angle of rotation of the main shaft 18, and the movement information (the positional deviation of the moving body 22). Further, the output generation unit 48 outputs the generated observation result to the display unit 34. More specifically, the output generation unit 48 includes a generation unit 50, and an output unit 52.

FIG. 5 is a diagram illustrating an observation result of the balance state of the main shaft 18 as observed by the observation device 12 according to the embodiment.

The generation unit 50 associates the angle of rotation of the main shaft 18 (see FIG. 3) and the positional deviation of the moving body 22 (see FIG. 4) with each other on the time axis. More specifically, the angle of rotation and the positional deviation that are detected at the same time are associated with each other. Consequently, the generation unit 50 generates an observation result (see FIG. 5). In the illustration of FIG. 5, the transitioning of the positional deviation (Pd) accompanying the rotation of the main shaft 18 is displayed in a polar coordinate format.

In FIG. 5, the distance from the origin indicates the magnitude of the positional deviation. The point Pd0 is a reference value of the positional deviation. In other words, at the point Pd0, the positional deviation is zero.

The output unit 52 outputs the observation result generated by the generation unit 50 to the display unit 34. The operator observes the displayed observation result. Consequently, the operator is capable of grasping changes in the positional deviation of the moving body 22 accompanying the rotation of the main shaft 18. More specifically, the operator can easily grasp any changes in the balance state of the main shaft 18 as it rotates.

An exemplary configuration of the observation device 12 has been described above. Subsequently, an observation method performed by the observation device 12 will be described.

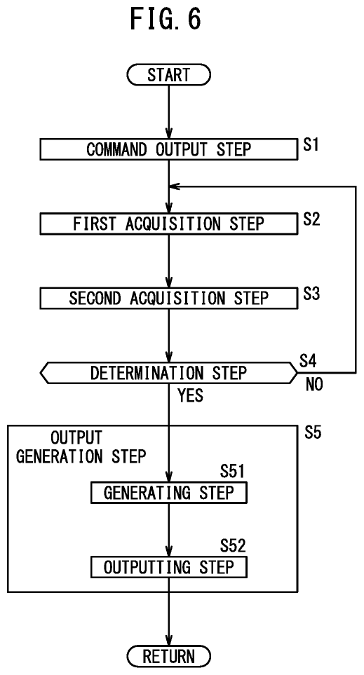

FIG. 6 is a flowchart illustrating a process flow of the observation method according to the embodiment.

The observation method according to the present embodiment includes a command output step (step S1), a first acquisition step (step S2), a second acquisition step (step S3), a determination step (step S4), and an output generation step (step S5).

First, the observation device 12 executes the command output step. In the command output step, the command output unit 43 outputs a command to the control device 16. This command includes the content of the observation control command 41. In accordance therewith, the main shaft 18 starts rotating. Further, the position of the moving body 22 is maintained at the predetermined position. Next, the observation device 12 executes the first acquisition step, and the second acquisition step. Moreover, it should be noted that the first acquisition step and the second acquisition step may be executed in parallel with each other.

In the first acquisition step, the first acquisition unit 44 acquires the angle of rotation of the main shaft 18 that rotates based on the command. The storage unit 38 stores the acquired angle of rotation of the main shaft 18. In the second acquisition step, the second acquisition unit 46 acquires the movement information (the positional deviation of the moving body 22) while the main shaft 18 is rotating. The storage unit 38 stores the acquired movement information.

While the second acquisition step (or the first acquisition step) is being performed, the moving body 22 vibrates in accordance with the rotation of the main shaft 18. Accordingly, the positional deviation acquired by the second acquisition unit 46 contains a large number of deviation components corresponding to the vibration of the main shaft 18.

In the determination step, the computation unit 40 determines whether or not the angles of rotation for one rotation of the main shaft 18 and the positional deviations for the one rotation of the main shaft 18 have been acquired. Such a determination is carried out based on information that is already stored in the storage unit 38. In this instance, in the case that the angles of rotation for one rotation of the main shaft 18 and the positional deviations for the one rotation of the main shaft 18 are not yet acquired (determination step: NO), the observation device 12 executes the first acquisition step and the second acquisition step one more time. On the other hand, in the case that the angles of rotation for one rotation of the main shaft 18 and the positional deviations for the one rotation of the main shaft 18 have been acquired (determination step: YES), the observation device 12 initiates a subsequent step.

The output generation step includes a generating step (step S51) and an outputting step (step S52). In the generating step, the generation unit 50 generates the observation result (FIG. 5) of the balance state of the main shaft 18. The observation result is generated by associating the angles of rotation of the main shaft 18 with the respective positional deviations. In the outputting step, the output unit 52 outputs the observation result generated in the generating step to the display unit 34. Consequently, the operator is capable of observing the balance state of the main shaft 18 via the display unit 34.

According to the present embodiment, it is possible to observe the balance state of the main shaft 18 without needing to rely on a field balancer. Further, according to the present embodiment, the operator can make use of an already existing machine tool 14, and an already existing control device 16. A description of an exemplary configuration of the observation method according to the present embodiment has been presented above.

The field balancer has a problem in that the observation accuracy of the balance state is unstable. More specifically, the accuracy in observing the balance state by the field balancer depends on the manner in which the field balancer is installed, and the position where the field balancer is installed. In contrast thereto, on the basis of the information acquired from the control device 16, the observation device 12 observes the balance state. Accordingly, the accuracy in observing the balance state by the observation device 12 is more stable than in the case in which the field balancer is used.

### [Exemplary Modifications]

Hereinafter, a description will be given concerning exemplary modifications of the embodiment. However, explanations that overlap with those of the embodiment will be omitted insofar as possible in the following description. Unless otherwise specified, the same reference numerals as in the embodiment are used in referring to the constituent elements that have already been described in the embodiment.

### (Exemplary Modification 1)

The observation device 12 may be provided in the control device 16. In accordance with this feature, for example, the display unit 34, the operation unit 36, the storage unit 38, and the computation unit 40 are realized by hardware of the control device 16.

### (Exemplary Modification 2)

The observation device 12 may initiate the generation of the observation result prior to completing the acquisition of the angles of rotation for one rotation of the main shaft 18, and the positional deviations of the moving body 22 for the one rotation of the main shaft 18. For example, accompanying the progression of the acquisition of the angles of rotation of the main shaft 18, and the acquisition of the positional deviations of the moving body 22, the observation device 12 may sequentially draw the observation result on the display unit 34. In this case, for example, the observation device 12 associates a first angle of rotation of the main shaft 18 with a first positional deviation of the moving body 22. The observation device 12 outputs the first angle of rotation and the first positional deviation to the display unit 34. Next, the observation device 12 associates a second angle of rotation of the main shaft 18 with a second positional deviation of the moving body 22. The observation device 12 outputs the second angle of rotation and the second positional deviation to the display unit 34.

### (Exemplary Modification 3)

The machine tool 14 is not limited to being a lathing machine, insofar as the machine tool 14 includes a rotating member (the main shaft 18), and a member (the moving body 22) that moves (vibrates) in accordance with the vibrations of the rotating member.

### (Exemplary Modification 4)

The main shaft 18 may be an air spindle that rotates in accordance with air that is supplied thereto.

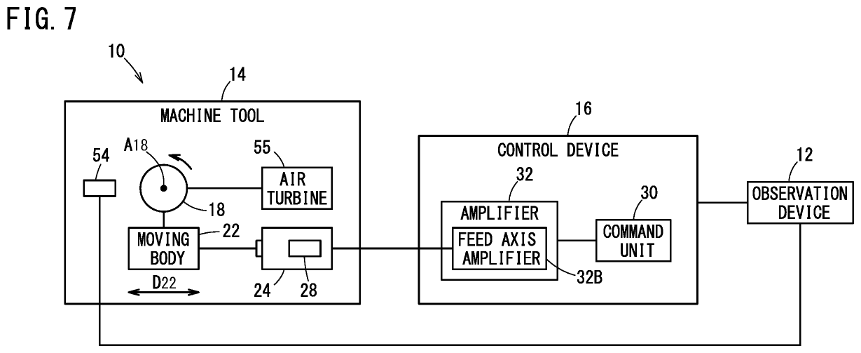

FIG. 7 is a configuration diagram of the observation system 10 according to an Exemplary Modification 4.

The main shaft 18 in FIG. 7 is an air spindle. In this case, the machine tool 14 of FIG. 7 is equipped with a third detector 54, and an air turbine 55. The third detector 54 is a sensor for detecting an angle of rotation of the main shaft 18.

Based on the detection result of the third detector 54, the first acquisition unit 44 acquires the angle of rotation of the main shaft 18. The air turbine 55 is a turbine for causing the main shaft 18 to rotate.

The third detector 54 shown in FIG. 7 is connected to the observation device 12. In this case, the third detector 54 inputs a signal corresponding to the rotation of the main shaft 18 to the observation device 12. However, the third detector 54 may input the signal corresponding to the rotation of the main shaft 18 to the control device 16. In that case, the observation device 12 may acquire the signal of the third detector 54 via the control device 16.

In the present exemplary modification as well, the field balancer is unnecessary.

### (Exemplary Modification 5)

In the following, a description is provided in a preliminary manner concerning matters to be investigated in relation to the feedback control of the feed axis motor 24. Further, on the basis of such a preliminary description, the observation device 12 according to an Exemplary Modification 5 will be described.

The responsiveness of the feedback control of the feed axis motor 24 changes in accordance with a gain. Typical examples of the gain include a position loop gain, a current loop gain, and a velocity loop gain.

Generally, the machining accuracy of the machine tool 14 increases as the gain becomes higher. Accordingly, in a general control of the machine tool 14, the gain is optimized to be a numerical value that is as high as possible.

Hereinafter, a state in which the gain is optimized for the purpose of carrying out processing in an accurate manner is referred to as a high gain state or a high gain. Further, a state in which at least one of the position loop gain, the current loop gain, or the velocity loop gain is lower than a set value of the high gain is referred to as a low gain state or a low gain. Based on the foregoing, the observation device 12 according to the present exemplary modification will be described.

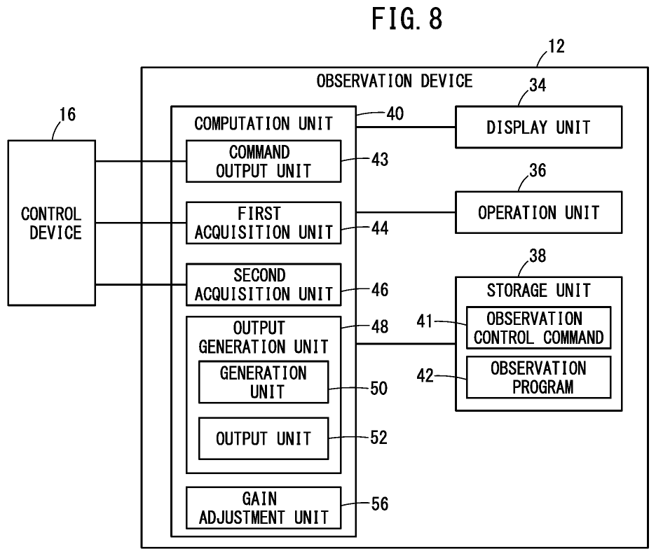

FIG. 8 is a configuration diagram of the observation device 12 according to an Exemplary Modification 5.

In the present exemplary modification, the second acquisition unit 46 acquires the movement information occurring while the feed axis motor 24 is controlled with a low gain. In this regard, the observation device 12 according to the present exemplary modification is further equipped with a gain adjustment unit 56. The gain adjustment unit 56 makes a request to the control device 16 (the command unit 30) to control the feed axis motor 24 with a low gain.

For example, the gain adjustment unit 56 makes a request to the control device 16 to lower the position loop gain. On the basis of such a request, the control device 16 lowers the position loop gain. Moreover, the gain adjustment unit 56 may also make a request to the control device 16 to lower the current loop gain or the velocity loop gain.

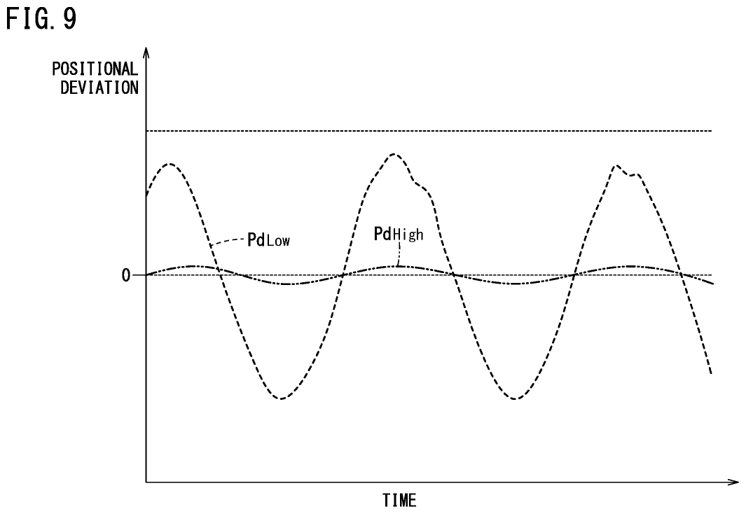

FIG. 9 is a graph illustrating the transitioning over time of the positional deviation of the moving body 22. Moreover, FIG. 9 illustrates the positional deviation for a case in which the feed axis motor 24 is controlled with a high gain, and the positional deviation for a case in which the feed axis motor 24 is controlled with a low gain.

Within FIG. 9, the two-dot dashed line Pd_{High} indicates the phase of the positional deviation obtained at a high gain. Within FIG. 9, the dashed line Pd_{Low} indicates the phase of the positional deviation obtained at a low gain. In the case of the low gain, the responsiveness of the control of the feed axis motor 24 is lower than in the case of the high gain. Accordingly, as compared with the positional deviation in the case of the high gain, the positional deviation tends to fluctuate more greatly in the case of the low gain.

That is, of the high gain and the low gain, the low gain makes it easier to reflect the influence of the balance state of the main shaft 18 on the positional deviation. Accordingly, from the standpoint of observing the balance state, a low gain is preferable to a high gain. As noted previously, the gain adjustment unit 56 makes a request to the control device 16 to control the feed axis motor 24 with a low gain. In accordance with this feature, it becomes easier for the second acquisition unit 46 to acquire the positional deviation in which the balance state of the main shaft 18 is more strongly reflected.

In the case that a balance state is not observed (in the case that the observation is completed), the gain adjustment unit 56 may return the gain setting to its original state (a high gain).

### (Exemplary Modification 6)

Hereinafter, supplementary matters in relation to the observation result (see FIG. 5) described in the embodiment will be described. Further, on the basis of such a supplementary description, the observation device 12 according to an Exemplary Modification 6 will be described.

The moving body 22 and the main shaft 18 are members that are separate from each other. Accordingly, a time lag occurs from when the main shaft 18 vibrates and until the vibration thereof is transmitted to the moving body 22. Depending on the time lag, the temporal phase of the positional deviation of the moving body 22 is delayed more so than the temporal phase of the angle of rotation of the main shaft 18. The specific examples of this feature will be described below. For example, in the following description, the angle of rotation of the main shaft 18 at time t is represented by α(t). The time lag is represented by t′. The angle of rotation of the main shaft 18 at time t+t′ is represented by α(t+t′). In the following description, the positional deviation of the moving body 22 at time t+t′ is represented by Pd(t+t′). The vibration generated in the main shaft 18 at time t is transmitted to the moving body 22 at time t+t′. In this case, the positional deviation Pd(t+t′) reflects the balance state of the main shaft 18 occurring at the angle of rotation of α(t). The positional deviation Pd(t+t′) does not reflect the balance state of the main shaft 18 occurring at the angle of rotation of α(t+t′).

In most cases, the aforementioned time lag is an extremely small time period. Accordingly, even if the time lag is ignored, the reliability of the observation result will not be significantly reduced. However, in order to improve the observation accuracy to the greatest extent possible, it is more preferable to take such a time lag into consideration.

Based on the foregoing description, the observation device 12 according to the present exemplary modification will be described.

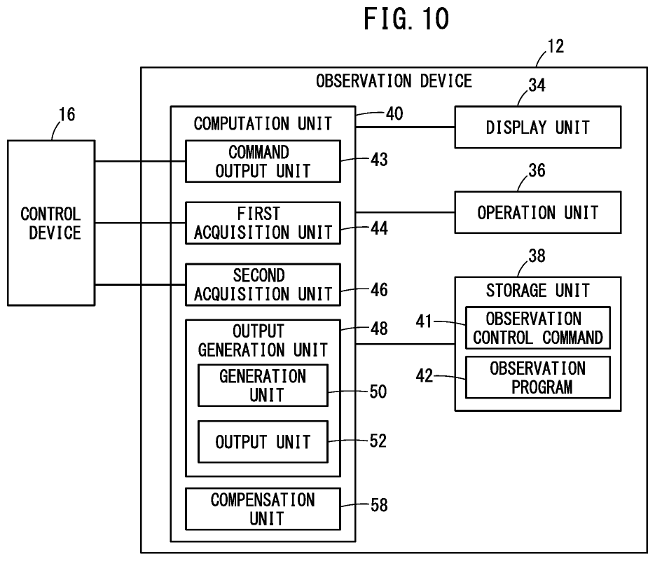

FIG. 10 is a configuration diagram of the observation device 12 according to the Exemplary Modification 6.

The observation device 12 according to the present exemplary modification is further equipped with a compensation unit 58. The compensation unit 58 compensates the angle of rotation of the main shaft 18 based on a compensation amount C. The compensation amount C is an amount of time representing the aforementioned time lag.

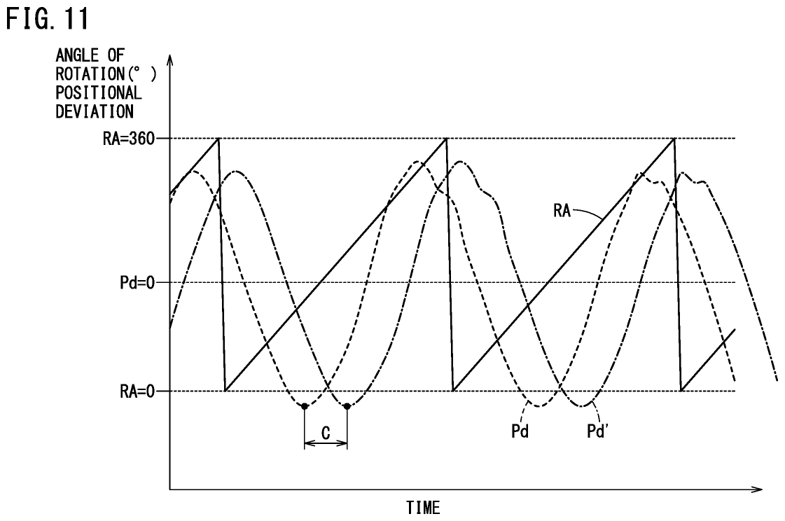

FIG. 11 is a graph illustrating phases, on a time axis, of the angle of rotation of the main shaft 18 and the positional deviation before and after being compensated by the compensation unit 58.

FIG. 11 shows a one-dot dashed line (Pd′), a dashed line (Pd), and a solid line (RA). The one-dot dashed line (Pd′) indicates a temporal phase of the positional deviation of the moving body 22 before being compensated. The dashed line (Pd) indicates a temporal phase of the positional deviation of the moving body 22 after being compensated. The solid line (RA) indicates a temporal phase (similar to FIG. 3) of the angle of rotation of the main shaft 18. The compensation unit 58 causes the temporal phase of the positional deviation (Pd′) to be advanced by the compensation amount C. Consequently, the generation unit 50 can precisely associate the angle of rotation (RA) of the main shaft 18 with the positional deviation (Pd′) of the moving body 22. For example, in the specific example described above, the generation unit 50 is capable of associating the angle of rotation α(t) with the positional deviation Pd(t+t′).

The time lag changes depending on the rotational speed of the main shaft 18. Accordingly, it is desirable to change the compensation amount C in accordance with the rotational speed of the main shaft 18. The compensation amount C for each of respective rotational speeds of the main shaft 18 is obtained on the basis of an experiment. Such an experiment is performed, for example, in the following manner. First, the person performing the experiment intentionally places the main shaft 18 in an unbalanced state. The person performing the experiment can place the main shaft 18 in an unbalanced state by attaching a (lead) weight to the main shaft 18. Next, the person performing the experiment observes the positional deviation of the moving body 22 while the main shaft 18 is being rotated at a specified rotational speed. Since the main shaft 18 is in an unbalanced state, the positional deviation of the moving body 22 differs for each of the angles of rotation of the main shaft 18. In this instance, based on the unbalanced angle (the position where the weight is mounted) of the main shaft 18, the person performing the experiment can predict the angle of rotation of the main shaft 18 corresponding to the maximum value of the positional deviation of the moving body 22. However, due to the aforementioned time lag, the angle of rotation of the main shaft 18 at the point in time when the positional deviation of the moving body 22 becomes maximum differs from the angle of rotation that is expected by the person performing the experiment. Accordingly, based on this angular difference, the person performing the experiment can inversely calculate the time lag (the compensation amount C) corresponding to the specified rotational speed of the main shaft 18.

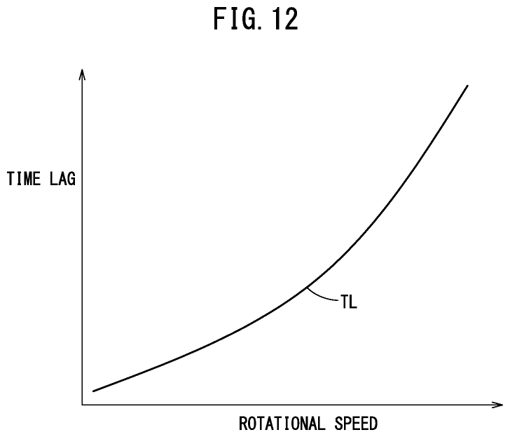

FIG. 12 is a graph for the purpose of describing a compensation amount C that is stored in the storage unit 38.

A solid line TL is illustrated in FIG. 12. The solid line TL indicates a change in the time lag (the compensation amount C) in accordance with the rotational speed of the main shaft 18. The corresponding relationship between the rotational speed of the main shaft 18 and the time lag (the compensation amount C) is stored in the storage unit 38. The compensation unit 58, by referring to the storage unit 38, properly uses the compensation amount C in accordance with the rotational speed of the main shaft 18. Consequently, the compensation unit 58 can accurately compensate the angle of rotation of the main shaft 18.

A plurality of the compensation amounts C are obtained by performing the aforementioned experiment a plurality of times while changing the rotational speed of the main shaft 18. The plurality of the obtained compensation amounts C can also be expressed in the form of a graph similar to that of FIG. 12 (however, wherein the vertical axis represents the compensation amounts C).

Moreover, it should be noted that the present modification is not limited to the description given above, and is capable of being further modified. For example, the aforementioned time lag differs depending not only on the rotational speed of the main shaft 18, but also on a load (mass) of the main shaft 18. Accordingly, the plurality of the compensation amounts C may be determined in accordance with the load of the main shaft 18. Further, some of the plurality of the compensation amounts C that are represented in a graph such as that of FIG. 12, for example, may be determined by interpolation (linear interpolation) based on certain other compensation amounts C that have already been determined. The specifics thereof will be described next. For example, in the case that the plurality of the compensation amounts C include a first compensation amount and a second compensation amount, based on the first compensation amount and the second compensation amount, a third compensation amount may be interpolated in the graph of FIG. 12. In this case, the interpolation, for example, is a linear interpolation.

### (Exemplary Modification 7)

Hereinafter, supplementary matters in relation to the observation result (see FIG. 5) described in the embodiment will be described below. Further, on the basis of such a supplementary description, the observation device 12 according to an Exemplary Modification 7 will be described.

The observation result shown in FIG. 5 is generated based on numerical values acquired from the control device 16. In this instance, the line (Pd) showing the transitioning of the positional deviation shown in FIG. 5 should be as smooth as possible to facilitate observation thereof by the operator.

Based on the foregoing description, the observation device 12 according to the present exemplary modification will be described.

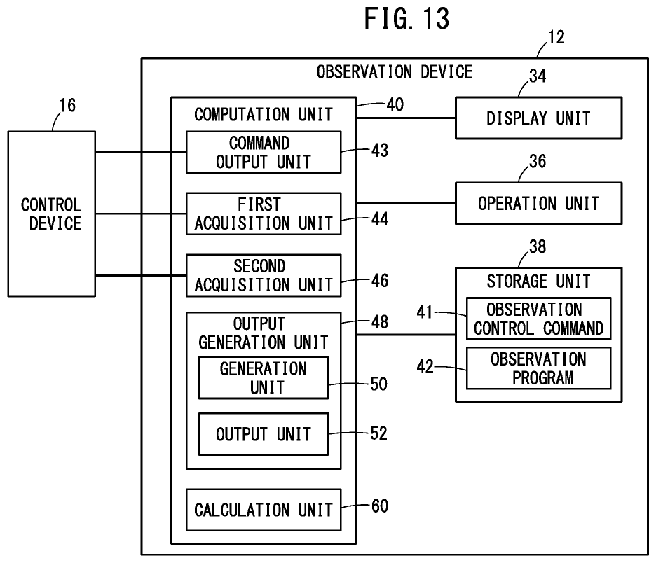

FIG. 13 is a configuration diagram of the observation device 12 according to the Exemplary Modification 7.

The observation device 12 according to the present exemplary modification is further equipped with a calculation unit 60. The calculation unit 60 determines an average value of a plurality of the positional deviations within each of a plurality of angular intervals.

The angular intervals are intervals into which the angle of rotation for one rotation (i.e., from 0 degrees to 360 degrees) of the main shaft 18 is divided by a predetermined angular width. The predetermined angular width, for example, is 5 degrees. In this case, the angle of rotation for one rotation of the main shaft 18 includes 72 angular intervals (e.g., an interval from 0 degrees to 5 degrees, an interval from 6 degrees to 10 degrees, . . . ). Moreover, it should be noted that the angular width is not limited to being 5 degrees, and the angular width may be changed as appropriate.

The calculation unit 60 refers to the result of the association between the angle of rotation of the main shaft 18 and the positional deviation of the moving body 22 performed by the generation unit 50. Moreover, since this association has already been described in the context of the embodiment, a description of this feature in the present exemplary modification is omitted. The calculation unit 60 calculates, for each of the angular intervals, an average value of a plurality of the positional deviations corresponding to a plurality of the angles of rotation included within each of the angular intervals. Based on the average value calculated by the calculation unit 60, the generation unit 50 re-associates the angle of rotation of the main shaft 18 with the positional deviation of the moving body 22. In this instance, for each of the angular intervals, the generation unit 50 associates a plurality of the angles of rotation included within the angular interval with the average value calculated for that angular interval.

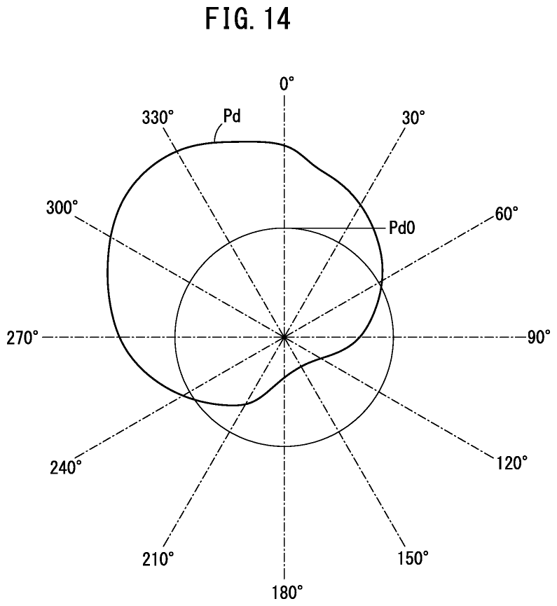

FIG. 14 is a diagram illustrating an observation result of the balance state of the main shaft 18 as observed by the observation device 12 according to the Exemplary Modification 7.

In FIG. 14, the transitioning of the positional deviation accompanying the rotation of the main shaft 18 is represented more smoothly than in FIG. 5. Accordingly, it becomes easier for the operator to observe the tendency of the change in the balance state of the main shaft 18.

### (Exemplary Modification 8)

The above-described calculation unit 60 may determine an average value of a plurality of the positional deviations, corresponding to each of the angles of rotation of the main shaft 18. That is, by the main shaft 18 being rotated a plurality of times, the second acquisition unit 46 is capable of acquiring a plurality of the positional deviations corresponding to the same angle of rotation. In this case, the calculation unit 60 may determine an average value of the plurality of the positional deviations.

In accordance with this feature, the positional deviation corresponding to each of the angles of rotation of the main shaft 18 is made smooth.

### (Exemplary Modification 9)

The above-described calculation unit 60 may determine a moving average of a plurality of the positional deviations during one rotation of the main shaft 18. For example, the observation device 12 acquires positional deviations (pd₁, pd₂, . . . , pdₙ) for a number n of rotations with respect to a certain angle of rotation α. In this case, the calculation unit 60 may determine the value of the moving average for such a number n of positional deviations. Further, the generation unit 50 may associate the rotation angle α with a moving average value of the number n of positional deviations (pd₁, pd₂, . . . , pdₙ). Moreover, the number n is a natural number.

In accordance with this feature, the positional deviation corresponding to each of the angles of rotation of the main shaft 18 is made smooth.

### (Exemplary Modification 10)

The movement information is not limited to being the positional deviation of the moving body 22. The observation device 12 may acquire as the movement information, for example, a drive position, a drive current, a velocity, a velocity deviation, an acceleration, an acceleration deviation, a jerk, or a jerk deviation of the feed axis motor 24.

The drive position, the drive current, the velocity, the velocity deviation, the acceleration, the acceleration deviation, the jerk, and the jerk deviation are information generally handled in the feedback control of the feed axis motor 24. Accordingly, in the same manner as the positional deviation, the observation device 12 is capable of acquiring from the control device 16 the drive position, the drive current, the velocity, the velocity deviation, the acceleration, the acceleration deviation, the jerk, or the jerk deviation.

In the present exemplary modification, for example, in the case that the velocity deviation is used as the movement information, the observation result illustrated in FIG. 5 or FIG. 14 includes, instead of the positional deviation, the velocity deviation of the feed axis motor 24 for each of the angles of rotation.

### (Exemplary Modification 11)

The output unit 52 may output the observation result to an external device of the observation device 12. The external device, for example, is the control device 16. That is, the display unit 34, which is an object to which the output unit 52 outputs the observation result, may be provided in an external device of the observation device 12.

Further, the external device may include an operation interface (input device). In this case, the observation device 12 may be operated via the operation interface of the external device. In this case, if unnecessary, the operation unit 36 may be omitted from the configuration of the observation device 12.

### (Exemplary Modification 12)

The above-described embodiment and the modifications thereof may be appropriately combined within a range in which no technical inconsistencies occur.

### Inventions that can be Obtained from the Embodiment

The inventions that can be grasped from the above-described embodiment and the modifications thereof will be described below.

### <First Invention>

The first invention is characterized by the observation device (12) that observes the balance state of the main shaft (18) of the machine tool (14), wherein the machine tool is equipped with the main shaft, and the moving body (22) to which the main shaft is fixed so as to be capable of rotating, and that moves in the direction (D₂₂) perpendicular to the axial direction of the main shaft, and the observation device includes the first acquisition unit (44) that acquires the angles of rotation of the main shaft that is rotating, the second acquisition unit (46) that acquires the movement information indicating the state of movement of the moving body at the time when the main shaft is rotating, and the output generation unit (48) that causes the display unit (34) to display each of the angles of rotation of the main shaft, and the movement information in association with each other.

In accordance with such features, the observation device is provided that observes the balance state of the main shaft of the machine tool, without needing to use a field balancer.

There may further be provided the command output unit (43) that controls the machine tool in a manner so that the main shaft rotates and the moving body does not deviate from the predetermined position. In accordance with this feature, the movement information does not contain a deviation component that is generated due to causing the moving body to move.

The machine tool may further include the main shaft motor (20) connected to the main shaft, and the detector (26) that detects the angles of rotation of the rotating shaft of the main shaft motor, wherein the main shaft is an electrically driven main shaft that rotates by being driven by the main shaft motor, and the first acquisition unit may acquire the angles of rotation of the main shaft based on a detection result of the detector. In accordance with such features, the angle of rotation of the electrically driven main shaft can be acquired without attaching a detector such as an acceleration pickup or the like to the main shaft separately from the configuration of the machine tool and the control device.

The machine tool may further include the detector (54) that detects the angles of rotation of the main shaft, the main shaft may be an air spindle that is rotated by air, and the first acquisition unit may acquire the angles of rotation of the main shaft based on the detection result of the detector. In accordance with such features, the angle of rotation of the air spindle can be acquired without attaching a detector such as an acceleration pickup or the like to the main shaft separately from the configuration of the machine tool and the control device.

The machine tool may further include the feed axis motor (24) that controls the movement of the moving body, and the second acquisition unit may acquire, as the movement information, a drive current, a drive position, a positional deviation, a velocity, a velocity deviation, an acceleration, an acceleration deviation, a jerk, or a jerk deviation of the feed axis motor. In accordance with such features, the movement information can be acquired without installing a detector for detecting the movement information separately from the configuration of the machine tool and the control device.

The first invention may further include the gain adjustment unit (56) which sets, when the movement information is acquired, a gain that controls the feed axis motor, to be lower than at the time when the machine tool is performing machining. In accordance with this feature, it becomes easier to acquire the movement information that facilitates reading of the tendency of the balance state.

The gain may include a position loop gain, a current loop gain, and a velocity loop gain of the feed axis motor, and when acquiring the movement information, the gain adjustment unit may cause at least one of the position loop gain, the current loop gain, or the velocity loop gain to be reduced.

The first invention may further include the storage unit (38) that stores, in accordance with the rotational speed of the main shaft, the plurality of the predetermined compensation amounts (C) each representing the time lag until the vibration generated by the rotation of the main shaft is transmitted to the moving body, and the compensation unit (58) that compensates the phase of the movement information on the time axis, based on the compensation amounts, wherein the output generation unit may cause each of the angles of rotation of the main shaft and the movement information that has been compensated, to be displayed in association with each other. In accordance with such features, the reliability of the observation result can be made more satisfactory.

In the first invention, the rotational phase for one rotation of the main shaft may include the plurality of angular intervals, the observation device may further include the calculation unit (60) that determines, for each of the plurality of angular intervals, the average value of the movement information at a time when the main shaft is rotating within a range of each of the angular intervals, and the output generation unit may cause the average value of the movement information determined for each of the plurality of angular intervals, to be displayed as the movement information corresponding to the range of each of the plurality of angular intervals. In accordance with such features, the movement information corresponding to each of the angles of rotation of the main shaft can be smoothed, and thus make it easier for the operator to observe the observation result.

The first invention may further include the calculation unit (60) that determines the average value of the plurality of pieces of the movement information, corresponding to each of the angles of rotation of the main shaft, the second acquisition unit may acquire the movement information over a period of a plurality of rotations of the main shaft, the calculation unit may determine the average value based on the movement information for the plurality of rotations acquired by the second acquisition unit, and the output generation unit may cause the determined average value, to be displayed as the movement information corresponding to each of the angles of rotation of the main shaft. In accordance with such features, the movement information corresponding to each of the angles of rotation of the main shaft can be smoothed, and thus make it easier for the operator to observe the observation result.

The first invention may further include the calculation unit (60) that determines the moving average of the movement information during one rotation of the main shaft, based on the plurality of pieces of the movement information corresponding to the one rotation of the main shaft, and the output generation unit may cause the determined moving average to be displayed as the movement information corresponding to each of the angles of rotation of the main shaft. In accordance with such features, the movement information corresponding to each of the angles of rotation of the main shaft can be smoothed, and thus make it easier for the operator to observe the observation result.

### <Second Invention>

The second invention is characterized by the observation method of observing the balance state of the main shaft (18) of the machine tool (14), wherein the machine tool is equipped with the main shaft, and the moving body (22) to which the main shaft is fixed so as to be capable of rotating, and that moves in the direction (D₂₂) perpendicular to the axial direction of the main shaft, the observation method including the first acquisition step of acquiring the angles of rotation of the main shaft that is rotating, the second acquisition step of acquiring the movement information indicating the state of movement of the moving body at the time when the main shaft is rotating, and the output generation step of causing the display unit (34) to display each of the angles of rotation of the main shaft, and the movement information in association with each other.

In accordance with such features, the observation method is provided that observes the balance state of the main shaft of the machine tool, without a field balancer.

There may further be included the command output step of controlling the machine tool in a manner so that the main shaft rotates and the moving body does not deviate from the predetermined position. In accordance with this feature, the movement information does not contain a deviation component that is generated due to causing the moving body to move.

The machine tool may further include the feed axis motor (24) that controls the movement of the moving body, and the observation method may further include the gain adjustment step of, when the movement information is acquired, setting the gain that controls the feed axis motor, to be lower than at the time when the machine tool is performing machining. In accordance with this feature, it becomes easier to acquire the movement information that facilitates reading of the tendency of the balance state.

The second invention may further include the storage step of storing, in accordance with the rotational speed of the main shaft, the plurality of the predetermined compensation amounts (C) representing the time lag until the vibration generated by the rotation of the main shaft is transmitted to the moving body, and the compensation step of compensating the phase of the movement information on the time axis, based on the compensation amounts, wherein, in the output generation step, each of the angles of rotation of the main shaft and the movement information that has been compensated may be displayed in association with each other. In accordance with such features, the reliability of the observation result can be made more satisfactory.

1. An observation device configured to observe a balance state of a main shaft of a machine tool, wherein:
the machine tool is equipped with the main shaft, and a moving body to which the main shaft is fixed so as to be rotatable and that is configured to move in a direction perpendicular to an axial direction of the main shaft; and
the observation device comprises:
a first acquisition unit configured to acquire angles of rotation of the main shaft that is rotating;
a second acquisition unit configured to acquire movement information indicating a state of movement of the moving body at a time when the main shaft is rotating; and
an output generation unit configured to cause a display unit to display each of the angles of rotation of the main shaft, and the movement information in association with each other.

2. The observation device according to claim 1, further comprising a command output unit configured to control the machine tool in a manner so that the main shaft rotates and the moving body does not deviate from a predetermined position.

3. The observation device according to claim 1, wherein:
the machine tool further comprises:
a main shaft motor connected to the main shaft; and
a detector configured to detect angles of rotation of a rotating shaft of the main shaft motor;
wherein the main shaft is an electrically driven main shaft that rotates by being driven by the main shaft motor; and
the first acquisition unit acquires the angles of rotation of the main shaft based on a detection result of the detector.

4. The observation device according to claim 1, wherein:
the machine tool further comprises a detector configured to detect the angles of rotation of the main shaft;
the main shaft is an air spindle configured to be rotated by air; and
the first acquisition unit acquires the angles of rotation of the main shaft based on a detection result of the detector.

5. The observation device according to claim 1, wherein:
the machine tool further comprises a feed axis motor 47 configured to control movement of the moving body, and
the second acquisition unit acquires, as the movement information, a drive current, a drive position, a positional deviation, a velocity, a velocity deviation, an acceleration, an acceleration deviation, a jerk, or a jerk deviation of the feed axis motor.

6. The observation device according to claim 5, further comprising a gain adjustment unit configured to set, when the movement information is acquired, a gain that controls the feed axis motor, to be lower than at a time when the machine tool is performing machining.

7. The observation device according to claim 6, wherein:
the gain includes a position loop gain, a current loop gain, and a velocity loop gain of the feed axis motor; and
when acquiring the movement information, the gain adjustment unit causes at least one of the position loop gain, the current loop gain, or the velocity loop gain to be reduced.

8. The observation device according to claim 1, further comprising:
a storage unity configured to store, in accordance with a rotational speed of the main shaft, a plurality of predetermined compensation amounts each representing a time lag until a vibration generated by rotation of the main shaft is transmitted to the moving body; and
a compensation unit configured to compensate a phase of the movement information on a time axis, based on the compensation amounts;
wherein the output generation unit causes each of the angles of rotation of the main shaft and the movement information that has been compensated, to be displayed in association with each other.

9. The observation device according to claim 1, wherein:
a rotational phase for one rotation of the main shaft includes a plurality of angular intervals;
the observation device further comprises a calculation unit configured to determine, for each of the plurality of angular intervals, an average value of the movement information at a time when the main shaft is rotating within a range of each of the angular intervals; and
the output generation unit causes the average value of the movement information determined for each of the plurality of angular intervals, to be displayed as the movement information corresponding to the range of each of the plurality of angular intervals.

10. The observation device according to claim 1, further comprising:
a calculation unit configured to determine an average value of a plurality of pieces of the movement information, corresponding to each of the angles of rotation of the main shaft;
the second acquisition unit acquires the movement information over a period of a plurality of rotations of the main shaft;
the calculation unit determines the average value based on the movement information for the plurality of rotations acquired by the second acquisition unit; and
the output generation unit causes the average value that has been determined, to be displayed as the movement information corresponding to each of the angles of rotation of the main shaft.

11. The observation device according to claim 1, further comprising:
a calculation unit configured to determine a moving average of the movement information during one rotation of the main shaft, based on a plurality of pieces of the movement information corresponding to the one rotation of the main shaft; and
the output generation unit causes the moving average that has been determined, to be displayed as the movement information corresponding to each of the angles of rotation of the main shaft.

12. An observation method of observing a balance state of a main shaft of a machine tool, wherein:
the machine tool is equipped with the main shaft, and a moving body to which the main shaft is fixed so as to be rotatable and that is configured to move in a direction (D₂₂) perpendicular to an axial direction of the main shaft;
the observation method comprising:
a first acquisition step of acquiring angles of rotation of the main shaft that is rotating;
a second acquisition step of acquiring movement information indicating a state of movement of the moving body at a time when the main shaft is rotating; and
an output generation step of causing a display unit to display each of the angles of rotation of the main shaft, and the movement information in association with each other.

13. The observation method according to claim 12, further comprising a command output step of controlling the machine tool in a manner so that the main shaft rotates and the moving body does not deviate from a predetermined position.

14. The observation method according to claim 12, wherein:
the machine tool further comprises a feed axis motor configured to control the movement of the moving body; and
the observation method further includes a gain adjustment step of, when the movement information is acquired, setting a gain that controls the feed axis motor, to be lower than at a time when the machine tool is performing machining.

15. The observation method according to claim 12, further comprising:
a storage step of storing, in accordance with a rotational speed of the main shaft, a plurality of predetermined compensation amounts each representing a time lag until a vibration generated by rotation of the main shaft is transmitted to the moving body; and
a compensation step of compensating a phase of the movement information on a time axis, based on the compensation amounts;
wherein, in the output generation step, each of the angles of rotation of the main shaft and the movement information that has been compensated are displayed in association with each other.
